(19) United States
(12) Patent Application Publication
(10) Pub. No.: US 2022/0158164 A1
(43) Pub. Date: May 19, 2022

(54) A PROCESS FOR PREPARING A COMPOSITE CATHODE FOR LITHIUM ION CELL

(71) Applicant: INDIAN SPACE RESEARCH ORGANISATION, Bangalore (IN)

(72) Inventors: Aravamuthan S., Thiruvananthapuram, Kerala (IN); Td Mercy, Thiruvananthapuram, Kerala (IN); John Bibin, Thiruvananthapuram, Kerala (IN)

(21) Appl. No.: 17/439,289

(22) PCT Filed: Mar. 10, 2020
(86) PCT No.: PCT/IN2020/050223

§ 371 Date: Sep. 14, 2021

(30) Foreign Application Priority Data
Mar. 14, 2019 (IN) 201941009925

(51) Int. Cl. H01M 4/131; H01M 4/525; H01M 4/505; H01M 10/0525; H01M 4/62

(52) U.S. Cl. CPC H01M 4/131; H01M 4/525; H01M 2004/028; H01M 10/0525; H01M 4/622; H01M 4/505

(57) ABSTRACT

The present application provides a process for preparing a composite cathode for a lithium ion cell comprising the steps of: (i) forming a cathode slurry in a planetary mixing machine by mixing an active material, conducting diluent and binder; (ii) coating the slurry over an aluminum foil substrate in a coating machine at a speed of 0.2-0.8 m/min; and (iii) calendering of the cathode in a calendering machine at a temperature of 50-150° C. The cathode has peel strength of greater than 200 gf/cm and moisture content less than 350 ppm. The lithium ion cell with the cathode disclosed in this invention and a graphite anode exhibited a capacity retention of >80% at 100% depth-of-discharge at C/2−1C charge-discharge rate when tested for 2000 cycles.

### FIELD OF INVENTION

The present invention pertains to a process for preparing a composite cathode. Specifically, the present invention pertains to a process for preparation of a composite cathode for lithium ion cells, having excellent peel strength, specific capacity and capacity retention.

### BACKGROUND OF INVENTION

In the recent years lithium ion cells have gained considerable attention as a power source for various applications viz. mobile phones, cameras, laptops and also for high-tech applications like military, aircraft, space and electric vehicles.

Generally the major components of a lithium ion cell include cathode, anode and electrolyte. The performance of a lithium ion cell is influenced by the properties of the electrodes used which in turn depend on type of materials employed, electrode composition and electrode processing technique.

A large number of lithiated metal oxides and phosphates have been employed as active material for cathode of lithium ion cells. The cathode material used in lithium ion cells should exhibit high specific capacity, good cycling performance, rate capability and safety features. In some cases as in satellite applications, it is required that the material should exhibit a sloping discharge curve instead of a flat one, so that it is possible to predict the state-of-charge at any point of time by checking the voltage of cell.

Substantial amount of research has been carried out to develop cathode materials, electrode compositions, and the process adopted thereof, for use in lithium ion cells with specific properties.

U.S. Pat. No. 5,672,446 patent discloses electrochemical cells where the cathode comprises lithiated cobalt oxides, lithiated manganese oxides, lithiated nickel oxides, LiₓNi_{1-y}Co_{y}O₂, where x is preferably about 1 and y is preferably 0.1-0.9, LiNiVO₄, or LiCoVO₄.

It is advantageous to provide an effective process to prepare a composite cathode which has desirable cathode properties like loading level, thickness, moisture content and peel strength to achieve good specific capacity and capacity retention and also a system for preparation of the same.

### OBJECT OF THE INVENTION

The object of the present invention is to provide a process for preparing a composite cathode for a lithium ion cell comprising the steps of: (i) forming cathode slurry in a planetary mixing machine by mixing an active material, conducting diluent and binder; (ii) coating the slurry over an aluminum foil substrate in a coating machine at a speed of 0.2-0.8 m/min; and (iii) calendering of the cathode in a calendering machine at a temperature of 50-150° C. for a lithium ion cell having excellent cathode properties for various applications including electric vehicles, launch vehicles, satellites, submarines, aircrafts etc.

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification are to be understood as being modified in all instances by the term “about”. It is noted that, unless otherwise stated, all percentages given in this specification and appended claims refer to percentages by weight of the total composition.

Thus, before describing the present invention in detail, it is to be understood that this invention is not limited to particularly exemplified systems or method parameters that may of course, vary. It is also to be understood that the terminology used herein is for the purpose of describing particular embodiments of the invention only, and is not intended to limit the scope of the invention in any manner.

The use of examples anywhere in this specification including examples of any terms discussed herein is illustrative only, and in no way limits the scope and meaning of the invention or of any exemplified term. Likewise, the invention is not limited to various embodiments given in this specification.

Unless otherwise defined, all technical and scientific terms used herein have the same meaning as commonly understood by one of ordinary skill in the art to which this invention pertains. In the case of conflict, the present document, including definitions will control.

It must be noted that, as used in this specification and the appended claims, the singular forms “a,” “an” and “the” include plural referents unless the content clearly dictates otherwise. Thus, for example, reference to a “polymer” may include two or more such polymers.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “comprising” “including,” “having,” “containing,” “involving,” and the like are to be understood to be open-ended, i.e., to mean including but not limited to.

In one aspect, the present application provides a process for preparing a composite cathode for a lithium ion cell comprising the steps of:
i. forming a cathode slurry in a planetary mixing machine by mixing an active material, conducting diluent and binder;
ii. coating the slurry over an aluminum foil substrate in a coating machine at a speed of 0.2-0.8 m/min; and
iii. calendering of the cathode in a calendering machine at a temperature of 50-150° C.

In an embodiment the cathode slurry is prepared in a planetary mixing machine by mixing the active material, conducting diluent and binder in the presence of a solvent.

In an embodiment the active material is selected from LiCoO₂, LiNiₓCo_{y}Al_{z}O₂, LiNiₓCo_{y}Mn_{z}O₂, and the like. In a preferred embodiment the active material is LiNiₓCo_{y}Al_{z}O₂.

In an embodiment the conducting diluent is selected from acetylene black, graphite, carbon nanotube etc., or a combination thereof. In a preferred embodiment a mixture of acetylene black and graphite is used as conducting diluent.

Acetylene black alone is widely used as a conducting diluent in cathode of lithium ion cells. It is a high-volume particle with an average particle diameter from several tens of nanometers to hundreds of nanometers. Because of this, the contact between acetylene black and an active material hardly becomes surface contact and tends to be point contact. Consequently, contact resistance between the active material and the conductive additive is high. Further, if the amount of the conductive additive is increased so as to increase contact points between the active material and the conductive additive, the proportion of the amount of the active material in the electrode decreases, resulting in the lower discharge capacity of the battery. To avoid this drawback existing in the prior art a mixture of acetylene black and graphite are used as conducting diluent in accordance with the present disclosure. This achieves uniform distribution of constituents and desirable cathode properties by increasing the specific capacity of the cathode.

In an embodiment the binder is selected from polyvinylidene fluoride (PVDF), poly(vinylidene fluoride-co-hexafluoropropylene), etc. In a specific embodiment the binder is polyvinylidene fluoride. The binder provides good adhesion between the constituent materials in the electrode as well as binding the constituent materials on substrate. The binder should be compatible with the materials used in the cell and also should exhibit electrochemical stability in the operating voltage window of the cell.

In an embodiment the solvent is selected from 1-methyl-2-pyrrolidinone (NMP), dimethyl acetamide (DMAC), dimethyl formamide (DMF), etc. In a preferred embodiment the solvent is 1-methyl-2-pyrrolidinone.

The process involves drying the ingredients prior to mixing in the planetary mixing machine. The moisture content in cathode is an important factor which affects the efficiency, reversible capacity and cycle life of lithium ion cells. The moisture content of the cathode becomes quite crucial for moisture sensitive materials like LiNiₓCo_{y}Al_{z}O₂. Therefore, the ingredients used for cathode slurry preparation are dried prior to mixing to remove moisture.

The powder materials except PVDF are dried at 150-230° C. for 20-36 hours under vacuum of 600-700 mm Hg. PVDF is dried at 50-80° C. for a period of 2-7 hours under vacuum of 600-700 mm Hg.

The formation of cathode slurry by mixing the active material, conducting diluent and binder is carried out in the planetary mixing machine. The ingredients of the cathode are fed into the planetary mixing machine through an inlet. The planetary mixing machine comprises planetary blades and high speed dispersers. Mixing of the ingredients in the planetary mixing machine ensures uniform mixing of ingredients and avoids pulverization of the active material, which thereby aids in achieving cathode with excellent performance attributes.

In an embodiment the planetary blade speed is in the range of 40-160 rpm.

In an embodiment the disperser speed is in the range of 450-600 rpm.

The sequence adopted for mixing of the ingredients is quite crucial in deciding the electrochemical properties of the cathode. In accordance with the present disclosure the cathode slurry formation process is carried out in a planetary mixing machine with high speed dispersers. The first step in cathode slurry preparation involves dry mixing of the powder materials at a lower speed followed by the addition of required quantity of PVDF solution. Then NMP is added at different intervals to reduce the viscosity of the cathode slurry to the desired level while continuing mixing.

The slurry processing is carried out in a humidity controlled environment with a relative humidity ranging from 2-15%.

In a specific embodiment the viscosity of the slurry is in the range of 2000 to 15000 cps at a speed of 100 rpm (measured in a Brookfield Viscometer RVDV-1 Prime using spindle S-06). The viscosity of slurry plays a critical role in deciding the properties of the electrodes. Viscosity decides the controllability in loading level, peel strength and thereby the performance of the electrode during cycling.

In an embodiment the active material is present in an amount ranging from 47 to 53 wt % based on the total weight of the cathode slurry.

In an embodiment the conducting diluent is present in an amount ranging from 2 to 6 wt % based on the total weight of the cathode slurry.

In an embodiment the binder is present in an amount ranging from 2 to 7 wt % based on the total weight of the cathode slurry.

In an embodiment the solvent is present in an amount ranging from 38 to 44 wt % based on the total weight of the cathode slurry.

The composition of the electrode is very important in deciding its electrochemical properties. The concentration of active material in electrodes determines the capacity delivered by the electrode. The conducting diluents are required for improving the conductivity of the electrode. Binder provides adhesion between the constituent materials in the electrode as well as binding the constituent materials on the substrate. High active material concentration results in high specific capacity. However, the optimum concentration of conducting diluent and binder is required for good cycle life and rate capability of the cell.

In a further step the process involves coating of the cathode slurry over an aluminum foil substrate in a coating machine. In an embodiment the aluminum foil substrate has a thickness in the range of 15 to 25 μm.

The coating of the cathode slurry over an aluminum foil substrate is carried out in the coating machine. The cathode slurry formed in the planetary mixing machine is transferred to a coating machine. The coating machine works on reverse comma principle. The gap between the reverse comma blade and applicator is first adjusted to get the desired loading level of the active material on the aluminum foil substrate. In an embodiment the gap set value is in the range of 150-300 μm.

The coating of the cathode slurry in accordance with the present disclosure comprises of: a) feeding the slurry into a slurry dam to initiate coating, b) transferring the slurry into the foil based on the gap between reverse comma blade and applicator, c) passing the foil coated with the slurry through two heating zones, d) after completing the coating on one side of the foil, it is reversed to make coating on other side of the foil.

The coating machine comprises a plurality of heating zones. The foil coated with the slurry passes through the heating zones. After completing the coating on one side of the foil, it is reversed to make coating on other side of the foil. The coating speed and temperature values are arrived at based on the drying of the cathode after passing through the two heating zones.

In an embodiment, the cathode is dried in heating zone at a temperature in the range of 50 to 150° C. in the coating machine.

The dried cathode is then finally wound in roll form. In an embodiment the coating speed is in the range of 0.2-0.8 m/min.

The coating environment plays a crucial role in deciding the properties of the cathode especially for moisture sensitive materials like LiNiₓCo_{y}Al_{z}O₂. If the moisture condition is not properly maintained the slurry becomes thicker making it difficult for the slurry to uniformly spread over the substrate during coating.

In an embodiment the coating process is carried out at a relative humidity in the range of 2 to 15%. The cathode after coating is further dried at a temperature in the range of 60 to 100° C. under vacuum in the range of 600-700 mmHg for a period of 3-10 hours. In an embodiment the thickness of the cathode after double side coating is in the range of 150 to 300 μm.

In a next step the process involves calendering of the cathode in a calendering machine. In an embodiment the calendering of the cathode is performed at a speed of 3 to 5 m/min. In an embodiment the calendering of the cathode is performed in the calendering machine at a temperature in the range of 50 to 150° C.

The calendering machine comprises a pre-heat zone and two heated rolls for pressing the cathode. The cathode thus formed in accordance with the present disclosure in the roll form is passed through the preheat zone and pressed in calendering machine rollers to a thickness of 140-200 μm at a speed of 3-5 m/min.

In an embodiment the temperature in the pre-heat zone is in the range of 80 to 150° C. In an embodiment the calender roll temperature is in the range of 50 to 100° C.

The cathode thus formed in accordance with the present disclosure is assembled against a graphite anode, to form a lithium ion cell. The lithium ion cell prepared in accordance with the present disclosure has exhibited excellent cell characteristics. The lithium ion cell with the cathode in accordance with the present invention and a graphite anode exhibited capacity retention of greater than 80% at 100% depth-of-discharge at C/2-1C charge-discharge rate when tested for 2000 cycles.

In an embodiment the peel strength of the cathode is in the range of 200 to 500 g_{f}/cm.

In an embodiment the specific capacity of the cathode is in the range of 160-165 mAh/g at 4.1 V at C/10 rate.

The composite cathode for a lithium ion cell in accordance with the present disclosure comprises (i) 70 to 93% of LiNiₓCo_{y}Al_{z}O₂, wherein x=0.8, y=0.15, and z=0.05; (ii) 2 to 15% of acetylene black; (iii) 2 to 15% of graphite; and (iv) 2 to 15% of polyvinylidene fluoride. In some embodiments the active material in composite cathode may also be lithium cobalt oxide, lithium nickel oxide, lithium nickel cobalt manganese oxide, lithium iron phosphate etc.

The following examples are provided to better illustrate the claimed invention and are not to be interpreted in any way as limiting the scope of the invention. All specific materials, and methods described below, fall within the scope of the invention. These specific compositions, materials, and methods are not intended to limit the invention, but merely to illustrate specific embodiments falling within the scope of the invention. One skilled in the art may develop equivalent materials, and methods without the exercise of inventive capacity and without departing from the scope of the invention. It is the intention of the inventors that such variations are included within the scope of the invention.

### EXAMPLES

The preparation of the composite cathode for a lithium ion cell with excellent cell characteristics is described in the following examples.

### Example 1

The electrode processing for LiNiₓCo_{y}Al_{z}O₂ based cathode is described below:

The cathode consists of LiNiₓCo_{y}Al_{z}O₂ as active material, a mixture of acetylene black and graphite as conducting diluent and polyvinylidene fluoride (PVDF) as binder. The electrode composition is LiNiₓCo_{y}Al_{z}O_{2:} 85-90%, acetylene black: 3-6%, Graphite: 4-7%, PVDF:3-8%. 1-methyl-2-pyrolidinone (NMP) is used as solvent for the processing of the electrode slurry. The active material, conducting diluent and PVDF are dried under vacuum prior to mixing. The electrode processing involves slurry preparation, electrode coating and calendering.

The slurry preparation is carried out in a planetary mixing machine with high speed dispersers. The slurry preparation involves dry mixing of LiNiₓCo_{y}Al_{z}O₂ and the conducting diluents in the mixing machine at a planetary blade speed of 50-80 rpm and disperser speed of 450-500 rpm followed by addition of polyvinylidene fluoride solution and addition of NMP at different intervals while continuing mixing at a planetary blade speed of 50-150 rpm. The volume of NMP is adjusted to get a slurry solid content of 60-62%.

The electrode coating is carried out in a coating machine which works on reverse comma principle. Aluminium foil with a thickness of 15 μm was used for coating. The gap between the reverse comma blade and applicator was adjusted to get a gap of 180-230 μm. The slurry is loaded to the slurry dam and coating is carried out. The coating is carried out at a speed of 0.4-0.7 m/min. The temperature of the heating zone is kept at 70-130° C. The electrode after drying is collected in roll form from the machine. The electrode is then dried at 60-100° C. for 5-7 h under vacuum. The thickness of the electrode after double side coating is 180-220 μm.

The calendering of the electrode is carried out in a calendering machine with pre-heat zone and calender rolls. The pre-heating temperature is 100-120° C. and calendering roll temperature is 50-80° C. The electrode in the roll form is passed through pre-heat rolls and calender rolls at a speed of 4-5 m/min to get a final electrode thickness of 140-170 μm.

### Example 2

The electrode processing for LiNiₓCo_{y}Mn_{z}O₂ based cathode is described below:

The cathode consists of LiNiₓCo_{y}Mn_{z}O₂ as active material, a mixture of acetylene black and graphite as conducting diluent and polyvinylidene fluoride (PVDF) as binder. The electrode composition is LiNiₓCo_{y}Mn_{z}O₂: 86-93%, acetylene black: 2-5%, Graphite: 3-7%, PVDF:2-6%. NMP is used as solvent. The active material, conducting diluent and PVDF are dried under vacuum prior to mixing. The electrode processing involves slurry preparation, electrode coating and calendering.

The slurry preparation is carried out in a planetary mixing machine with high speed dispersers. A 5-10% (by weight) solution of PVDF is prepared in NMP. The dry mixing of LiNiₓCo_{y}Mn_{z}O₂ and the conducting diluents is carried out in the mixing machine at a planetary blade speed of 50-100 rpm and disperser speed of 450-550 rpm. Then polyvinylidene fluoride solution is added, followed by the addition of NMP at different intervals while continuing mixing at a planetary blade speed of 60-150 rpm. The volume of NMP is adjusted to get a slurry solid content of 58-62%.

The electrode coating is carried out in a coating machine which works on reverse comma principle. Aluminium foil with a thickness of 20 μm was used for coating. The gap between the reverse comma blade and applicator was adjusted to get a gap of 230-250 μm. The slurry is loaded to the slurry dam and coating is carried out. The coating is carried out at a speed of 0.3-0.7 m/min. The temperature of the heating zone is kept at 80-130° C. The electrode after drying is collected in roll form from the machine. The electrode is then dried at 80-100° C. for 5-7 h under vacuum. The thickness of the electrode after double side coating is 200-240 μm.

The calendering of the electrode is carried out in a calendering machine with pre-heat zone and calender rolls. The pre-heating temperature is 100-120° C. and calendering roll temperature is 60-90° C. The electrode in the roll form is passed through pre-heat rolls and calender rolls at a speed of 4-5 m/min to get a final electrode thickness of 160-190 μm.

### Example 3

The electrode processing for LiCoO₂ based cathode is described below:

The cathode consists of LiCoO₂ as active material, a mixture of acetylene black and graphite as conducting diluent and polyvinylidene fluoride (PVDF) as binder. The electrode composition is LiCoO₂: 87-93%, acetylene black: 2-5%, Graphite: 2-4%, PVDF: 3-5%. 1-methyl-2-pyrolidinone (NMP) is used as solvent for the processing of the electrode slurry. The active material, conducting diluent and PVDF are dried under vacuum. The electrode processing involves slurry preparation, electrode coating and calendering.

The slurry preparation is carried out in a planetary mixing machine with high speed dispersers. The slurry preparation involves dry mixing of LiCoO₂ and the conducting diluents in the mixing machine at a planetary blade speed of 40-90 rpm and disperser speed of 450-550 rpm followed by addition of polyvinylidene fluoride solution and addition of NMP at different intervals while continuing mixing at a planetary blade speed of 50-150 rpm. The volume of NMP is adjusted to get a slurry solid content of 57-60%.

The electrode coating is carried out in a coating machine which works on reverse comma principle. Aluminium foil with a thickness of 15-20 μm is used for coating. The gap between the reverse comma blade and applicator was adjusted to get a gap of 250-300 μm. The slurry is loaded to the slurry dam and coating is carried out. The coating is carried out at a speed of 0.4-0.6 m/min. The temperature of the heating zone is kept at 75-135° C. The electrode after drying is collected in roll form from the machine. The electrode is then dried at 70-100° C. for 5-7 h under vacuum. The thickness of the electrode after coating is 260-300 μm.

The calendering of the electrode is carried out in a calendering machine with pre-heat zone and calender rolls. The pre-heating temperature is 100-120° C. and calendering roll temperature is 50-80° C. The electrode in the roll form is passed through pre-heat rolls and calender rolls at a speed of 4-5 m/min to get a final electrode thickness of 170-200 μm.

TABLE 1
Performance attributes of the composite cathode (for LiNiₓCo_{y}Al_{z}O₂)

| S No | Cathode property | Value | |
|---|---|---|---|
| 1 | Peel strength | >200 | g_{f}/cm |
| 2 | Loading level | 10-20 | mg/cm² |
| 3 | Thickness | 100-200 | μm |
| 4 | Moisture content | <350 | ppm |

| | | |
|---|---|---|
| 5 | Specific capacity | 160-165 mAh/g at 4.1 |
| | | V at C/10 rate |

TABLE 2
Performance attributes of the lithium ion cell comprising the composite
cathode (based on LiNiₓCo_{y}Al_{z}O₂ and graphite anode)

| | Lithium cell | |
|---|---|---|
| S No | property | Value |
| 1 | Cycle life | 2000 (C/2 charge, 1 C |
| | | discharge, @ 100% |
| | | depth-of-discharge |
| 2 | Capacity retention | >80% |
| 3 | Coulombic | >99% |
| | Efficiency | |

1. A process for preparing a composite cathode for a lithium ion cell comprising the steps of:
i. forming a cathode slurry in a planetary mixing machine by mixing ingredients comprising an active material, a conducting diluent and a binder;
ii. coating the cathode slurry over an aluminum foil substrate in a coating machine at a speed of 0.2-0.8 m/min; and
iii. calendering of the cathode in a calendering machine at a temperature of 50-150° C.

2. The process as claimed in claim 1, comprising drying the ingredients prior to mixing in the planetary mixing machine.

3. The process as claimed in claim 1, wherein step (i) is performed in the presence of a solvent.

4. The process as claimed in claim 1, wherein the active material is selected from the group consisting of LiCoO₂, LiNiₓCo_{y}Al_{z}O₂, and LiNiₓCo_{y}Mn_{z}O₂.

5. The process as claimed in claim 1, wherein the conducting diluent is selected from the group consisting of acetylene black and graphite.

6. The process as claimed in claim 1, wherein the conducting diluent is a combination of acetylene black and graphite.

7. The process as claimed in claim 1, wherein the binder is selected from the group consisting of polyvinylidene fluoride (PVDF) and poly(vinylidene fluoride-co-hexafluoropropylene).

8. The process as claimed in claim 3, wherein the solvent is selected from the group consisting of 1-methyl-2-pyrrolidinone (NMP), Dimethyl acetamide (DMAC), and Dimethyl formamide (DMF).

9. The process as claimed in claim 1, wherein an amount of the active material is in a range of 47 to 53 wt % based on a total weight of the cathode slurry.

10. The process as claimed in claim 1, wherein an amount of the conducting diluent is in a range of 2 to 6 wt % based on a total weight of the cathode slurry.

11. The process as claimed in claim 1, wherein an amount of the binder is in a range of 2 to 7 wt % based on a total weight of the cathode slurry.

12. The process as claimed in claim 3, wherein an amount of the solvent is in a range of 38 to 44 wt % based on a total weight of the cathode slurry.

13. The process as claimed in claim 1, wherein the active material and the conducting diluent are dry mixed first, followed by an addition of a binder solution and further addition of a solvent at different time intervals, while continuing mixing.

14. The process as claimed in claim 1, wherein the aluminum foil substrate has a thickness in a range of 15 to 25 μm.

15. The process as claimed in claim 1, wherein a thickness of the cathode after coating is in a range of 150 to 300 μm.

16. The process as claimed in claim 1, wherein a final thickness of the cathode after calendering is in a range of 140 to 200 μm.

17. The process as claimed in claim 1, wherein a relative humidity of a room in which the coating is carried out is in a range of 2 to 15%.

18. The process as claimed in claim 1, comprises drying the cathode in a drying zone after coating at a temperature in a range of 50 to 150° C. in the coating machine.

19. The process as claimed in claim 1, wherein the calendering of the cathode is performed at a speed of 3 to 5 m/min and at a temperature in a range of 50-150° C.
